(19) United States
(12) Patent Application Publication
(10) Pub. No.: US 2008/0251684 A1
(43) Pub. Date: Oct. 16, 2008

(54) Electric appliance with constant power supplied-bus

(76) Inventor: Ya-Ping Huang, Tainan County (TW)

Correspondence Address: Joe McKinney Muncy, PO Box 1364, Fairfax, VA, 22038-1364, US

(21) Appl. No.: 11/783,841

(22) Filed: Apr. 12, 2007

(51) Int. Cl. F16M 1/04

(52) U.S. Cl. 248/674; 248/200

(57) ABSTRACT

The present invention provides a labor-saving device for a fan head including a first driving module fixed on a supporting base board, a second driving module fixed on a connecting board, and an elastic element, wherein each driving module is composed of a motor, a curved handle and a connecting block. The first driving module fixed on the supporting base board is responsible for a back and forth horizontal movement, and the second driving module fixed on the connecting board is responsible for a back and forth vertical movement. The elastic element is mounted between the supporting base board and the connecting board for buffering the torque differential between the two motors, which are respectively moved in a horizontal direction and a vertical direction, so as to save labor of the fan head and further increase the life time of the fan head system.

### FIELD OF THE INVENTION

The present invention is related to a labor-saving device for fan head, and more particularly to a fan head swing system which can swing in horizontal and vertical directions at the same time.

### BACKGROUND OF THE INVENTION

Conventionally, the fan head swing system is driven by one horizontal module and one vertical driving module, and owing to the torque differential produced between the rotating motors of two driving modules, the swing life time of the fan head swing system is reduced.

### SUMMARY OF THE INVENTION

The object of the present invention is to provide a labor-saving device for fan head which can be applied to a common swing head device for increasing the life time thereof, and more particularly, which can be applied to a fan head device driven by plural motors, so as to achieve simplicity and lasting.

For achieving the object described above, the present invention includes a first driving module fixed on a supporting base board, a second driving module fixed on a connecting board, and an elastic element, each driving module is composed of a motor, a curved handle and a connecting block. The first driving module fixed on the supporting base board takes one end of the curved handle as a fixed point and connects to the connecting block and the motor so as to be responsible for a back and forth horizontal movement, and the second driving module fixed on the connecting board takes one end of the curved handle as a fixed point and connects to the connecting block and the motor so as to be responsible for a back and forth vertical movement. The elastic element is mounted between the supporting base board and the connecting board for buffering the torque differential between the two motors, which are respectively moved in a horizontal direction and a vertical direction, so as to save labor of the fan head and further increase the life time of the fan head system.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional decomposition drawing of the present invention;

FIG. 2 is a three-dimensional schematic view showing the arrangement of the present invention;

FIG. 3A is a schematic view showing one kind of horizontal movement of the present invention;

FIG. 3B is a schematic view showing another kind of horizontal movement of the present invention;

FIG. 4A is a schematic view showing one kind of vertical movement of the present invention;

FIG. 4B is a schematic view showing another kind of vertical movement of the present invention;

FIG. 5A is a schematic view showing one kind of movement of elastic element according to the present invention; and

FIG. 5B is a schematic view showing another kind of movement of elastic element according to the present invention.

### DESCRIPTION OF THE PREFERRED EMBODIMENT

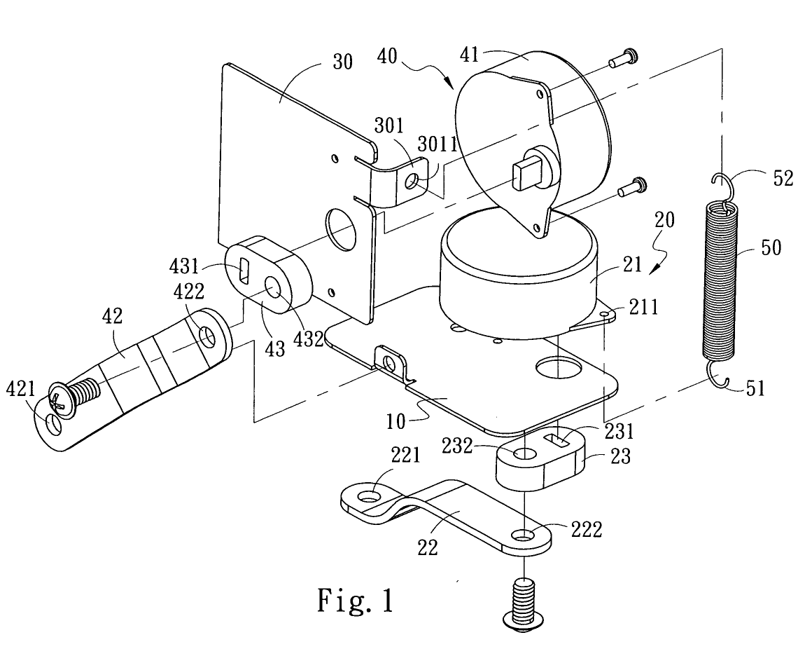

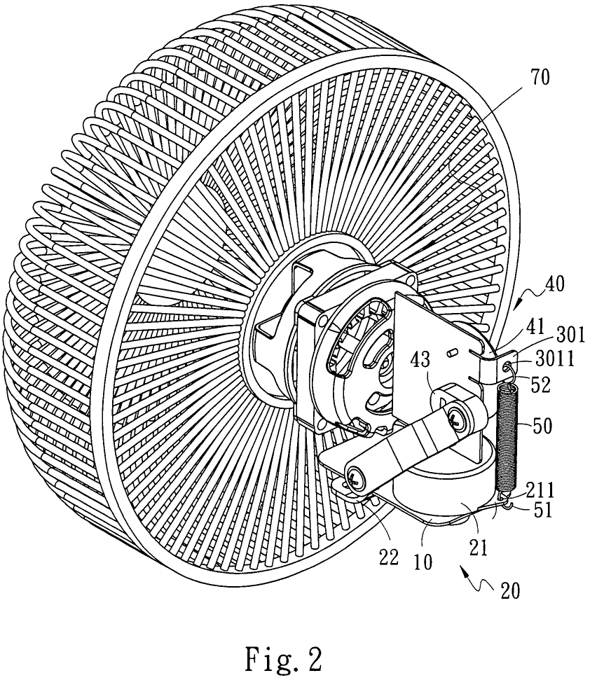

Please refer to FIGS. 1 and 2. The present invention is related a labor-saving device mounted on a fan head 70 and includes a first driving module 20 fixed on a supporting base board 10, a second driving module 40 fixed on a connecting board 30, and an elastic element 50, wherein the first driving module 20 is composed of a motor 21, a curved handle 22 and a connecting block 23, the second driving module 40 is composed of a motor 41, a curved handle 42 and a connecting block 43, and the elastic element 50 is mounted between the supporting base board 10 and the connecting board 30.

Preferably, the elastic element 50 which can be stretched and recovered, as shown in FIGS. 1 and 2, can be a spring, an elastic piece or a rubber element.

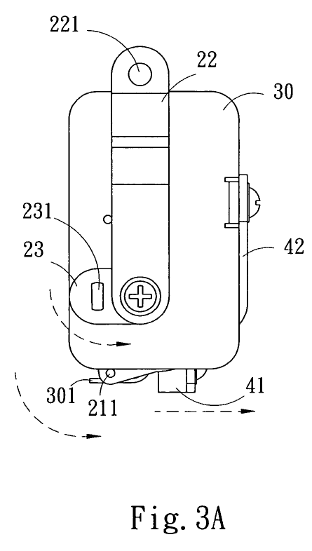

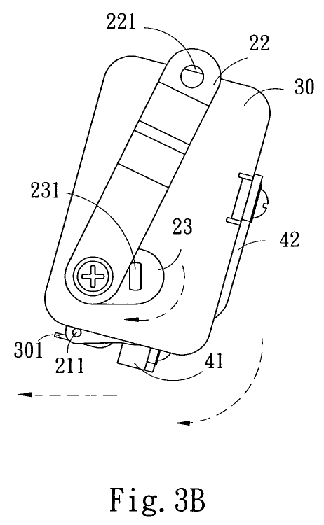

As shown in FIGS. 1, 3A and 3B, the first driving module 20 fixed on the supporting base board 10 takes a turning axial-hole 221 of the curved handle 22 as the fixed point and connects to the motor 21 through the connecting block 23, so that when the motor 21 turns, the connecting block 23 drives the curved handle 22 to have a horizontal movement so as to achieve a back and forth horizontal swing of the fan head 70, wherein one end of the connecting block 23 has an embedding slot 231 having a shape corresponding to the axle center of the motor 21, and the other end has a positioning hole 232 corresponding to the fixed axial hole 222 of the curved handle 22.

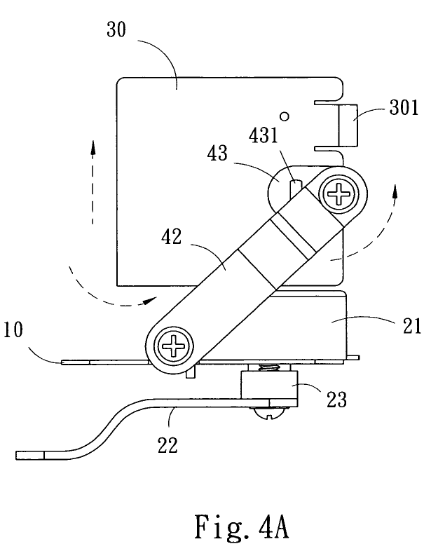

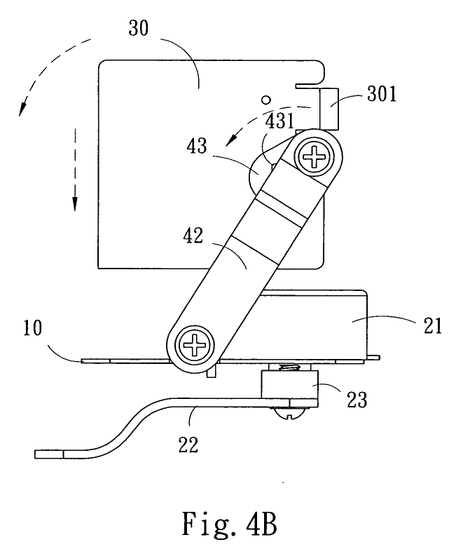

Please refer to FIGS. 1, 4A and 4B. The second driving module 40 fixed on the connecting board 30 takes a turning axial-hole 421 of the curved handle 42 as the fixed point and connects to the motor 41 through the connecting block 43, so that when the motor turns, the connecting block 43 drives the curved handle 42 to have a vertical movement so as to achieve a back and forth vertical swing of the fan head 70, wherein one end of the connecting block 43 has an embedding slot 431 having a shape corresponding to the axle center of the motor 41, and the other end has a positioning hole 432 corresponding to the fixed axial hole 422 of the curved handle 42.

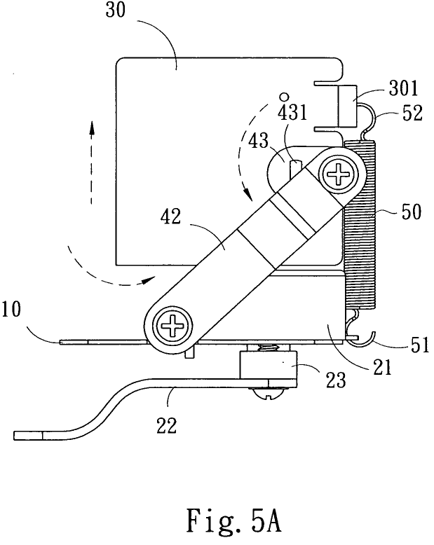

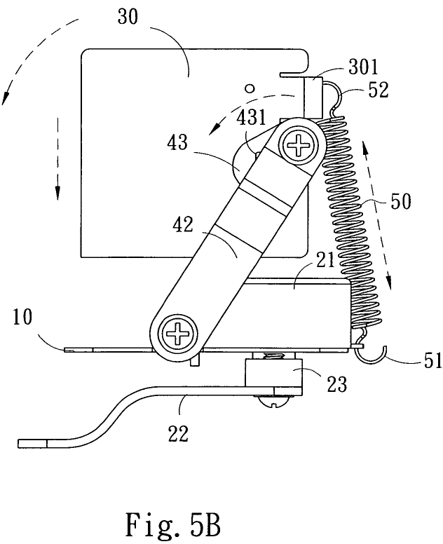

Please refer to FIGS. 1, 5A and 5B. In the embodiment, one end of the elastic element 50 has a hooking portion 51 hooked in a through hole 211 of the motor 21 on the supporting base board 10, and the other end has a hooking portion 52 is hooked in a through 3011 of a flat 301 extended from the side edge of the connecting board 20. Through the stretch and recovery of the elastic element 50 buffering the torque differential between the two motors 21, 42, which are respectively moved in a horizontal direction and a vertical direction, the first driving module 20 on the supporting base board 10 and the second driving module 40 on the connecting board 30 can be moved simultaneously, so as to save labor of the fan head 70 and further increase the life time of the fan head system 70.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A labor-saving device for a fan head, comprising a first driving module fixed on a supporting base board, a second driving module fixed on a connecting board, and an elastic element, wherein
the first driving module comprises a motor, a curved handle and a connecting block and takes a turning axial-hole of the curved handle as the fixed point and connects to the motor through the connecting block, so that when the motor turns, the connecting block drives the curved handle to have a horizontal movement so as to achieve a back and forth horizontal swing of the fan head;
the second driving module takes a turning axial-hole of the curved handle as the fixed point and connects to the motor through the connecting block, so that when the motor turns, the connecting block drives the curved handle to have a vertical movement so as to achieve a back and forth vertical swing of the fan head; and
the elastic element is mounted between the supporting base board and the connecting board, and through the stretch and recovery of the elastic element buffering the torque differential between the two motors, which are respectively moved in a horizontal direction and a vertical direction, the first driving module on the supporting base board and the second driving module on the connecting board are capable of moving at the same time, so as to save labor of the fan head and further increase the life time of the fan head.

2. The labor-saving device for fan head as claimed in claim 1, wherein the elastic element is a spring.

3. The labor-saving device for fan head as claimed in claim 2, wherein one end of the elastic element has a hooking portion hooked in a through hole of the motor on the supporting base board, and the other end has a hooking portion is hooked in a through of a flat extended from the side edge of the connecting board.

4. The labor-saving device for fan head as claimed in claim 1, wherein the elastic element is an elastic piece.

5. The labor-saving device for fan head as claimed in claim 1, wherein the elastic element is a rubber element.
